(19) United States
(12) Patent Application Publication
(10) Pub. No.: US 2016/0140590 A1
(43) Pub. Date: May 19, 2016

(54) MANAGING RESOURCE ACCESS USING MULTIPLE SERVICE CATEGORIES

(71) Applicant: International Business Machines Corporation, Armonk, NY (US)

(72) Inventors: Jakub Marecek, Dublin (IE); Robert Shorten, Mulhuddart (IE); Fabian R. Wirth, Dunboyne (IE); Jia Y. Yu, Quebec (CA)

(21) Appl. No.: 14/543,228

(22) Filed: Nov. 17, 2014

(51) Int. Cl. G06Q 30/02

(52) U.S. Cl. CPC G06Q 30/0206

(57) ABSTRACT

In order to modulate consumer usage of service categories for accessing a resource, an electronic service menu is first transmitted by a computer system. The electronic service menu includes a cost indicator and a benefit indicator for each of the service categories. Subsequent to the transmission of the electronic service menu, consumer usage data about each of the service categories is tracked. The consumer usage data is then analyzed. Based on this analysis, the service capacity of at least one of the service categories is adjusted. Also based on the analysis, a revised electronic service menu is transmitted by the computer system. The revised electronic service menu includes at least one revised cost indicator and at least one revised benefit indicator.

### BACKGROUND

The present disclosure relates to managing resource access, and more specifically, to managing resource access in systems having multiple service categories with variable service capacities.

Consumers often have multiple options for accessing a particular resource. In some situations, these options may take the form of different service categories, which may refer to at least two distinct types of differentiation in resource access. In a first type, service categories may refer to multiple queues for accessing a resource. For example, there may be several different lines of people formed outside of a sports stadium, with each line being a separate queue (e.g., an individual service category) for getting into the stadium. In a second type, service categories may refer to multiple subtypes within a given resource. These subtypes may be different levels of a resource (e.g., a product or service) or different variations within a common resource. For example, in the context of mobile internet access (a resource) there may be two different subtypes (service categories), such as the third generation of mobile telecommunications technology “3G” (a slower, lower level of the resource) and the fourth generation of mobile telecommunications technology “4G” (a faster, higher level of the resource). For another example, in the context of streaming video provisioning (a resource) there may be several different service categories offered, such as mobile streaming (a narrow bandwidth, lowest level of the resource), standard streaming (a broader, second tier level of the resource), high-definition television “HDTV” (a broadband subtype of the resource), and ultra high definition television “4K” (the highest quality service category of the four).

Various degrees of overlap or combinations between these two distinct types of service categories are also possible. For example, in the context of an airport check-in desk, there could be three different waiting lines (service categories as queues) with the lines having passengers who will fly in first class, business class, and economy class, respectively (service categories as resource subtypes).

### SUMMARY

According to embodiments of the present disclosure, aspects of the disclosure may include a method, a system, and a computer program product for using a computer system for modulating consumer usage of service categories for accessing a resource. Each service category may have a service capacity. An electronic service menu may be transmitted by the computer system. The electronic service menu may include a cost indicator and a benefit indicator for each of the service categories. Subsequent to the transmission of the electronic service menu, consumer usage data about each of the service categories may be obtained. The consumer usage data may then be analyzed. Based on this analysis, the service capacity of at least one of the service categories may be adjusted. Also based on the analysis, a revised electronic service menu may be transmitted by the computer system. The revised electronic service menu may include at least one revised cost indicator and at least one revised benefit indicator.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of some embodiments and do not limit the disclosure.

FIG. 1 illustrates a flowchart of an example method for modulating consumer usage of service categories for accessing a resource, in accordance with embodiments of the present disclosure.

FIG. 2 illustrates a block diagram, depicted at a first time interval, of an example queue management system configured to manage consumer usage of a set of queues for accessing a resource, in accordance with embodiments of the present disclosure.

FIG. 3 illustrates a block diagram of the example queue management system 200 of FIG. 2 depicted at a second time interval, in accordance with embodiments of the present disclosure.

FIG. 4 illustrates a block diagram, depicted at a first time interval, of an example resource subtype management system configured to manage consumer usage of a set of resource subtypes for accessing a resource, in accordance with embodiments of the present disclosure.

FIG. 5 illustrates the example resource subtype management system of FIG. 4 depicted at a second time interval, in accordance with embodiments of the present disclosure.

FIG. 6 illustrates a high-level block diagram of an example computer system that may be used in implementing one or more of the methods described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to managing resource access, and more specifically, to managing resource access in systems having multiple service categories with variable service capacities. While the present disclosure is not necessarily limited to such applications, various aspects of the disclosure may be appreciated through a discussion of various examples using this context.

When managing consumer usage of service categories, an entity may have several goals in mind. These goals may span a broad range, including, for example, revenue optimization or crowd control. In working toward achieving any of these goals, there may be some advantage to being able to successfully modulate consumer behavior. More particularly, being able to convince consumers (e.g., customers) to choose one service category over another (or, potentially, convincing a consumer to choose none of the service categories) may have implications on the entity's ability meet its consumer usage goals.

There may be several tools that can aid in this process. Among these tools are cost controls and service capacity controls. By controlling the costs of service categories for accessing its resource, an entity may be able to convince consumers to use its service categories at different relative rates. In particular, by increasing the cost of one service category, an entity may be able to do one or more of: increasing its profits from that service category, decreasing consumer usage of that service, and increasing consumer usage of another service category. As used herein, costs may be positive or negative (e.g., they may refer to both prices charged to consumers and rewards given to consumers). Controlling service capacities (e.g., the maximum allowed capacity for a service category, the quantity of assets allocated to serve consumers of a service category) may also have consumer usage implications. For example, by increasing the service capacity of a service category, the level of performance in that service category may increase and more consumers may select it.

Another tool that may aid in modulating consumer selection of service categories for accessing a resource is consumer signaling. By providing consumers with signals about the status of service categories (e.g., prior to their selection of one particular service category), consumers may be able to make better informed decisions that may ultimately benefit both themselves and the entity providing the resource. Furthermore, adjustments in these signals may cause consumers to respond in predictable ways. This may mean that resource providers may be able to modulate consumer behavior by adjusting the signals they transmit to consumers (e.g., without actually adjusting the service capacity of any service categories).

In some embodiments, consumer signals may take the form of electronic service menus that display relevant service category information to consumers. These electronic service menus may be transmitted to consumers in a variety of forms. For example, an electronic service menu may be displayed on a large electronic billboard with a chart of relevant information that may be automatically updated by a computer system. For another example, an electronic service menu may be sent in the form of a text message to the phones of individual consumers.

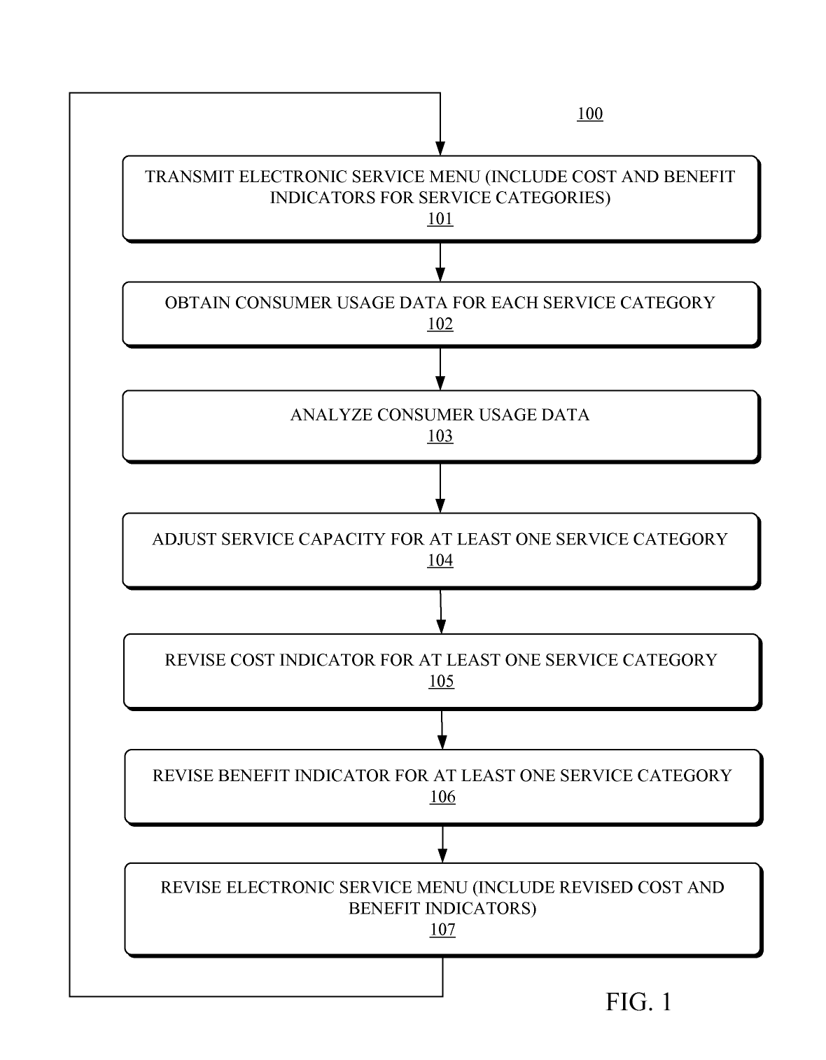

Turning now to FIG. 1, shown is a flowchart of an example method 100 for modulating consumer usage of service categories for accessing a resource, in accordance with embodiments of the present disclosure. The method may begin at block 101 where an electronic service menu is transmitted (e.g., transmitted to consumers). The electronic service menu may include a cost indicator and a benefit indicator for each of the service categories. As used herein, a cost indicator and a benefit indicator may each refer to any indication of the cost or benefit (respectively) to the consumer of selecting a particular service category at a particular time or over a particular time range. In some embodiments, examples of indicators may include actual values (e.g., actual costs, actual benefits), maximum values, estimated values, or ranges of values. Further, in some embodiments, benefit indicators may be associated with performance levels or service capacities of particular service categories (e.g., estimated wait times). For example, in the context of streaming video, benefit indicators may include measures of resolution, packet loss, frame loss, other perceptual quality measures, etc. Also, benefit indicators may be calculated or determined using a number of different methods. For example, in calculating a benefit indicator that is a performance estimate for a particular service category for a particular time interval, several different types of data may be relied on (e.g., performance data about that particular service category in the immediately preceding time interval, historical data about similar service categories in various time intervals). Furthermore, in some embodiments, several different factors or measures of performance may be considered in establishing a benefit indicator. In some embodiments, each of these performance measures may be displayed separately within a single benefit indicator (e.g., a benefit indicator including both “wait time of 20 minutes” and “consumer satisfaction score of 10”). In other embodiments, these performance indicators may be weighed and combined to make a single benefit indicator score.

Next, per block 102, consumer usage data may be obtained for each service category. This may occur, for example, by tracking consumer usage of each of the service categories. The amount and type of data obtained may vary depending upon the context. In some embodiments, the obtained data may include the amount of time that each consumer spends in a particular service category (e.g., how long each consumer waits in line at a given queue). Further, in some embodiments, the obtained data may include the total number of people using a particular service category at a given time or over a given time interval (e.g., how many consumers are using a particular resource subtype at a particular time). Consumer usage data may be collected on an individual level, for each consumer, or may be collected on a group level or as an average (e.g., the average time that all of the consumers in a given queue waited to be served). In some embodiments, consumer usage data may be obtained by tracking consumer usage of service categories using one or more electronic input devices. An electronic input device may include, for example, a camera or a microphone. In some embodiments, the one or more electronic input devices may include one or more automated sensors configured to monitor consumer activity. In some embodiments, such an automated sensor could include a motion-sensor attached to a camera that causes the camera to take photos of the consumers as they enter a particular queue. In some other embodiments, such an automated sensor could include an electronic sensor on a turnstile configured to be triggered each time a consumer enters a particular queue.

Per block 103, the consumer usage data may then be analyzed. This analysis may occur at discrete time intervals or may be ongoing. Based on the analysis, adjustments may be made, per block 104, to the service capacity of at least one service category. In some embodiments, the service capacities of all of the service categories may be adjusted. These adjustments may take the form of increasing or reducing the assets that are available to a particular service category. For example, the service capacity of a queue at an airport check-in desk could be reduced by decreasing the number of ticket agents (assets) that are serving that queue. Furthermore, in some embodiments, additional infrastructure may need to be used in order to increase service capacities at times of high demand. For example, in the provisioning of streaming video or wireless internet connectivity, additional cell towers may need to be accessed to meet demand. Furthermore, adjustments in service capacities may be linked between two or more service categories and their relative allowances of an asset. For example, in the context of a power grid for lighting up a given area (e.g., with light being the resource of interest) the service capacity of a first lighting system (first service category) could be increased at the same time the service capacity of a second lighting system (second service category) is decreased by shifting a portion of the electrical charge (asset) from the second lighting system to the first lighting system. Furthermore, in some embodiments, the total service capacity of the resource may be adjusted by changing the individual service capacities of at least one of the service categories (including, possibly, all of the service categories). For example, by increasing the service capacity of a single queue, without modifying the service capacities of any of the other queues, the total, combined service capacities of all of the queues (e.g., the total service capacity for accessing the resource) may effectively be increased. In another example, by adjusting the service capacities of all the queues, the net effect may be that the total service capacity for accessing the resource may be increased, decreased, or remain the same.

Per block 105, at least one of the cost indicators may be revised. Likewise, per block 106, at least one of the benefit indicators may be revised. The choice as to which indicators to revise may be based on the analysis of the consumer usage data. Further, in some embodiments, the revision of cost and benefit indicators may be linked with the adjustment of service capacities. For example, if the service capacity of a particular service category is reduced, then transmitting a reduced cost indicator for that service category or a reduced benefit indicator for that service category (or both) may be appropriate.

Per block 107, a revised electronic service menu may be created. This revised electronic service menu may constitute all or a portion of a new signal (e.g., a new signal transmitted to consumers). In some embodiments, the revised electronic service menu may include at least one revised cost indicator, at least one revised benefit indicator, or both. The method 100 may then be repeated in a loop, with the revised electronic service menu being transmitted (per block 101) and the cycle being repeated.

It is contemplated that, in some embodiments, one or more of the steps or functionalities of the method 100 may be carried out by a computer system. This computer system may include, for example, a computer that is operated by the manager of the resource being accessed by consumers.

Other variants on method 100 are also contemplated. In particular, in some embodiments, the number of service categories (e.g., the cardinality of the service categories for accessing a resource) may be adjusted in response to consumer usage data. This may occur in addition to, or instead of, adjusting the service capacity of the service categories. For example, if a queue (service category) is used by consumers sparingly or not at all, then it may be appropriate to close that queue down.

In another variant on method 100, in some embodiments, different signals (e.g., different electronic service menus) may be sent to different consumers or sets of consumers, rather than having all consumers receive the same signal. This may help to avoid having too many consumers select one service category at the same time. In some embodiments, the selection of which consumers receive which signals may be made randomly. In other embodiments, more (or less) favorable signals (e.g., electronic service menus with better (or worse) cost or benefit indicators) may be sent to more (or less) favorable consumers (e.g., consumers with favorable (or less favored) credit scores, consumers that are repeat customers).

In yet another variant on method 100, in some embodiments where cost indicators for service categories are presented in electronic service menus as ranges of costs, the selection of an actual cost to charge a consumer who responded to the electronic service menu may be made at the time the consumer accesses the resource. For example, a consumer may receive an electronic service menu indicating a cost of $5-$10 for entering a particular queue during a particular time interval. The consumer may enter the queue without knowing the precise cost within that $5-$10 range that he will ultimately be charged. In some embodiments, the amount actually charged to that consumer may be determined based on analyzing consumer usage data about that queue. For example, if consumer usage data indicates that the consumer waited a relatively short time in the queue, then the consumer may be charged a relatively high price (e.g., $9 or $10). As another example, the consumer could be presented with a base price (e.g., $10) and a discount amount that varies according to wait time (e.g., $0-$5).

In yet another variant on method 100, in some embodiments, cost or benefit indicators for service categories may be obtained by analyzing and applying risk measures, such as value at risk (VaR) or expected shortfall measures.

In yet another variant on method 100, in some embodiments, cost or benefit indicators for service categories may be presented to consumers as histograms. For example, a consumer may receive an electronic service menu indicating (e.g., as part of a benefit indicator) that a perceptual quality score of 5-10 on some scale has been obtained 99% of the time that other consumers have entered a particular queue (service category) during a particular time period, while a perceptual quality score of 8-10 has only been obtained 80% of the time for that same queue over that same time period. This information could then be used by the consumer to inform his choice as to whether or not he should enter that queue now.

In yet another variant on method 100, in some embodiments involving service categories as queues, the cost actually charged (or paid if it is a reward) to a consumer upon the consumer's arrival at the head of a queue (e.g., at the time the consumer is provided access to the resource) may be a function of the length of that queue at the time the consumer joined that queue (at its tail). Furthermore, in some embodiments, the costs charged to consumers at the times they arrive at the heads of queues may be used in generating future (revised) cost indicators that may be transmitted in revised electronic service menus to the other consumers (e.g., those who have not yet selected a queue). For example, all of the costs charged to consumers arriving at the head of queue A over a particular time interval may be averaged and that averaged cost may serve as a revised cost indicator to other consumers (e.g., by providing them an estimate of what they can expect to pay if they join queue A).

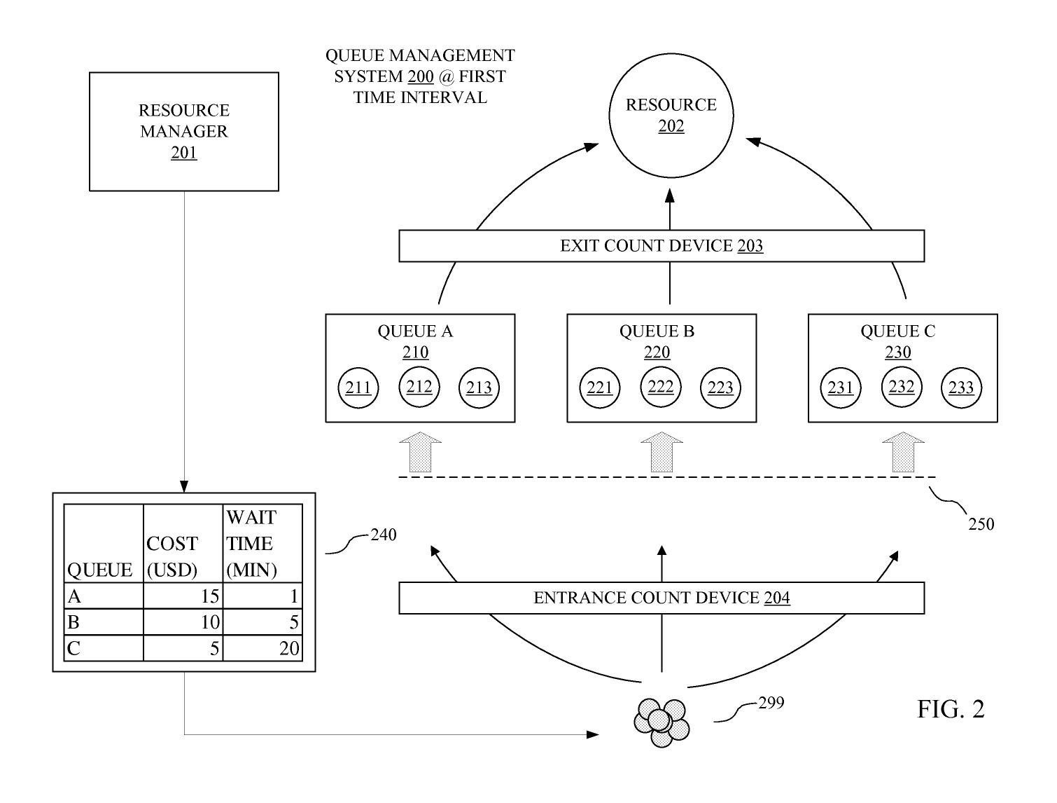

Turning now to FIG. 2, shown is a block diagram, depicted at a first time interval, of an example queue management system 200 configured to manage consumer usage of a set of queues for accessing a resource, in accordance with embodiments of the present disclosure. When using the queue management system 200, consumers 299 desiring access to resource 202 may be required to join one of three queues: queue A 210, queue B 220, and queue C 230. As shown, each queue includes three assets of the nine total assets (represented by assets 211-213, assets 221-223, and assets 231-233, respectively). In some embodiments, the number of assets associated with each queue may directly related to the service capacity of that particular queue. When deciding which queue to join, consumers 299 may have some ability to make informed decisions by using an electronic service menu 240 transmitted to them by a resource manager 201. As shown, the electronic service menu 240 includes for each queue a cost indicator (cost for joining that queue in US dollars) and a benefit indicator (estimated wait time for each queue in minutes).

Based their review of the electronic service menu 240, consumers 299 may each choose which one of the three queues (210, 220, or 230) they would like to enter. Upon entering any queue, an entrance count device 204 may detect which queue the consumer entered. Similarly, an exit count device 203 may be used to detect consumers as they exit their respective queues and gain access to the resource 202. In some embodiments, count devices 203 and 204 may be physical devices for counting individuals (e.g., turnstiles) or they may incorporate electronic ways of counting (e.g., software designed to track consumers' actions while they are attempting to access the resource, turnstiles that include automated sensors). Further, in some embodiments, data collected from count devices 203 and 204 may constitute consumer usage data about the queues and may be transmitted to the resource manager 201 for analysis. In some embodiments, the resource manager 201 may be able to use this data to obtain insights about the capacities of each of the queues 210, 220, and 230. For example, by counting consumers as they enter and exit queues, a resource manager 201 may be able to determine the current length of any given queue. And by continuing this counting over a period of time, the resource manager 201 may be able to track the rates (e.g., in the form of averages) that consumers are served within each queue.

In some embodiments, a resource manager 201 may calculate optimal lengths (or optimal service rates) for each of the queues. These calculations may be made based on both consumer usage data collected by the resource manager 201 and the one or more goals of the system. For example, given the consumer usage data received by the resource manager 201 at the first time interval, it may determine an optimal length for each queue (e.g., using optimizer software). In the depicted example, the optimal length is represented by the dotted line 250 and the length of each queue is represented by the length of a corresponding shaded arrow. As shown, all three queue lengths are close to optimal. Accordingly, with regard to the service capacities of the queues 210, 220, and 230 and the indicators of electronic service menu 240, any adjustments may be minimal and may be designed to maintain the status quo. In some embodiments, the queues may have different desired queue lengths (e.g., relative to their respective costs and a goal of increasing profit).

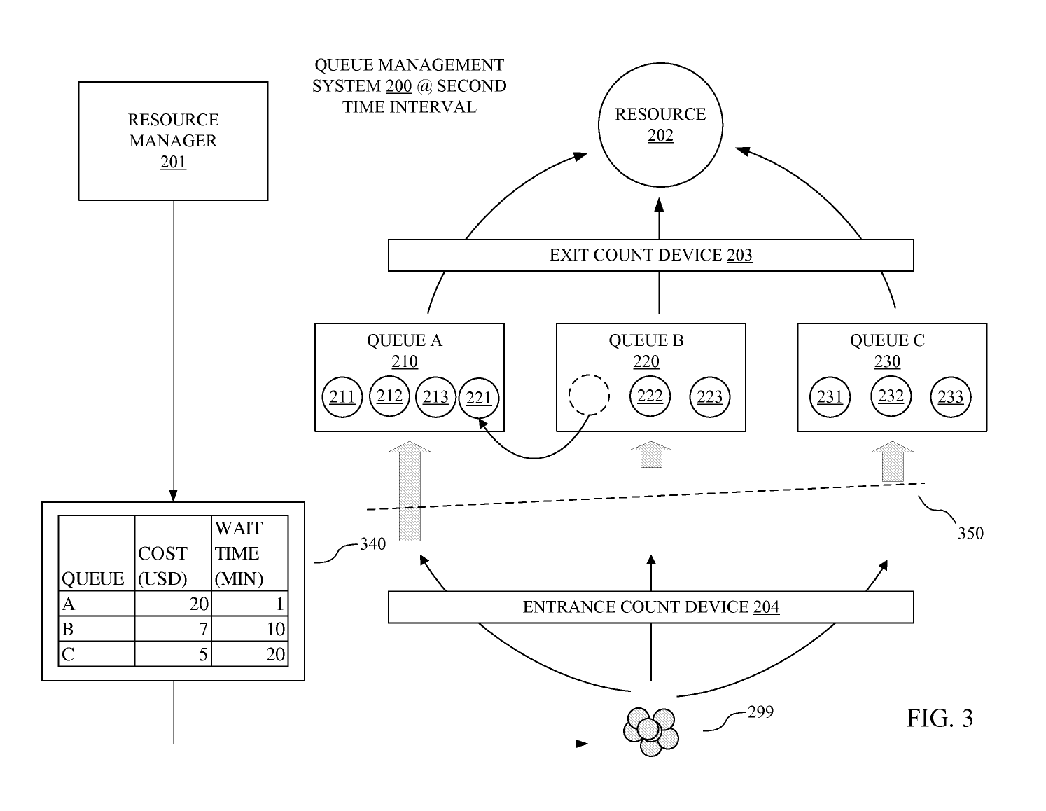

Turning now to FIG. 3, shown is the example queue management system 200 of FIG. 2 depicted at a second time interval, in accordance with embodiments of the present disclosure. At this time, based on consumer usage data, the resource manager 201 may determine that, relative to their respective lengths at the first time interval, the length of queue A 210 has increased, the length of queue B 220 has decreased, and the length of queue C 230 has remained approximately the same. This new consumer usage data may be used to make new optimal length calculations for the queues. The newly calculated optimal lengths are represented by the dotted line 350. In order to meet this optimization goal, the resource manager may cause the service capacity of queue B 220 to be decreased and the service capacity of queue A 210 to be increased by shifting asset 221 from queue B 220 to queue A 210. In addition, a revised electronic service menu 340 may be transmitted to the consumers 299. This electronic service menu may have differences from the previously transmitted electronic service menu 240. For example, as shown, the cost indicator of queue A 210 shows an increased cost from 15 to 20, the cost indicator of queue B 220 shows a decreased cost from 10 to 7, and the benefit indicator of queue B 220 shows an increased wait time (e.g., a decreased benefit) from 5 to 10 minutes. By making these adjustments to the service capacity of the queues and to electronic service menu 340, the queue management system 200 may be able to modulate the behavior of the consumers 299 in such a manner that its consumer usage goals are achieved.

In some embodiments, the electronic service menus described herein may be represented using algebraic expressions. For example, consider a resource manager that manages a resource in the context of queues as service categories. At each time-step t, the resource manager may ensure a service capacity for each queue q (each of which may, in some embodiments, have a variable service capacity). Also at each time-step t, the resource manager may decide on the number of queues Q to have open. The resource manager may then send an electronic service menu M to the consumers that may include a cost indicator c and a benefit indicator b for each queue q during the time-step t. This electronic service menu may be represented by the expression Mₜ={(cₜ, bₜ)|q ∈ Qₜ}. Using this expression, for each different time-step, the resource manager may vary any of the number of queues, the cost indicator for each queue, and the benefit indicator for each queue.

To aid understanding, the use of algebraic expressions in an example airline context is provided herein. In this example, there is a system operator (e.g., airline company), which operates a resource having service categories (e.g., check-in counters at the airport) of variable capacities. In this example, at each time-step t, the system operator pays for capacity of the resource and decides on the number of queues Qₜ^{max} to open. Let i ∈ {1, . . . , I} denote a consumer (e.g., a passenger). In order to use the resource, the consumers have to queue in one or more queues Qₜ=1, 2,. . . , Qₜ^{max}. At the time of service, each consumer is rewarded (or charged, if the reward is negative), based on several factors, including the queue that the consumer has been waiting in, the wait time, the signal that the consumer received, etc. Throughout the process of serving consumers the decision as to which, if any, queue gets served at any time, is up to the system operator to decide. How this example works may be represented by a loop of the following three steps:

STEP 1: The operator sends a “price menu” M_{t,i}=(s₁, s₂, . . . , s_{Q}_{ₜ}_{^{max}} to consumer i at time t, where each tuple s_{q}=(r̅_̅{̅t̅,̅i̅}̅^̅{̅q̅}̅,p̅_̅{̅t̅,̅i̅}̅^̅{̅q̅}̅),q ∈ Qₜ may represent a signal that may include an indicator on the price (r̅_̅{̅t̅,̅i̅}̅^̅{̅q̅}̅ ∈ Rⁿ and signals on m≧0 measures of performance (p̅_̅{̅t̅,̅i̅}̅^̅{̅q̅}̅ ∈ R^{m} for queue q at time t.

STEP 2: Each consumer i chooses the queue q ∈ Q that the consumer wants to join and joins the queue at the tail (i.e., gets served no earlier than consumers who have joined queue q earlier).

STEP 3: It is up to the operator to decide whether to serve a consumer from any queue, and if so, from which queue. This affects the rate of service (and potentially all other measures of quality of service). At the same time, the operator has to decide how much to reward (how much to charge) the consumers, whether to pay for extra capacity (e.g., so that more consumers could be served or served at a faster rate), and what signals (e.g., electronic service menus) to send to the consumers next.

In some embodiments, the system operator may have the power to vary the number of queues, the total capacity used to serve the queues, and the prices and rates of processing within each queue. For example, the system operator could potentially save some costs by reducing the total capacity, slowing down some queues, and lowering their prices. Furthermore, in some embodiments, changes to service capacity may correspond to hiring additional temporary staff or paying staff for over-time. These changes may be bounded by some capacity limits and the payments for extra service capacity may have non-linear relationships with the total service capacity. Furthermore, in some embodiments, an example of a price menu M=((p₁,r₁), (p₂,r₂)) could consist of the price p₁ for “priority service” with a wait time bounded from above by r₁ , and a price p₂ for the other, non-priority queue with the wait-time bounded from above by r₂ , wherein r₂<< r₁ . Another example price menu) M=((p₁), (p₂), (p₃)) could consist of the price p₁ for “coach class”, p₂ for “business class”, and p₃ for “economy class”.

Additional algebraic expressions are also discussed herein. Some embodiments may include a mechanism for operating a set of queues Qₜ such that one or more of the following are varied, or optimized with respect to one or more goals (e.g., profit), concurrently:
the cardinality of the set |Qₜ|,
the rate rₜ^{q} at which resources serve consumers in each queue q ∈ Qᵢ,i≦t,
the price rₜ^{q} ∈ R of processing consumers in each queue q ∈ Qₜ,
r_̅{̅t̅,̅i̅}̅^̅{̅q̅}̅ ∈ Rⁿ a signal to send to consumer i on the price rₜ^{q} of processing consumers in each queue q ∈ Qₜ, and
a signal p_̅{̅t̅,̅i̅}̅^̅{̅q̅}̅ ∈ R^{m} to send to consumer i on the performance of processing consumers in each queue q ∈ Qₜ, with respect to m measures of performance.

Other features of such a mechanism for operating this set of queues Qₜ may include:
a price menu denoted as the set M={(r̅ₜ̅^̅{̅q̅}̅,p̅ₜ̅^̅{̅q̅}̅)|q ∈ Qₜ},
a limitation on a time-varying rate rₜ at which resources must serve consumers, such that the rate is bounded by r≦rₜ<r̅,
a measure of total profits that is given by the sum of charges collected from consumers minus a function of any additional capacity, F(rₜ−r), bought to serve them.
a measure of the performance for each queue q that is a function in the form of (r₁^{q},r₂^{q}, . . . , r_{t hu q})→R, and
a different measure of the performance for each queue q that is function in the form of (r₁^{q},r₂^{q}, . . . ,rₜ^{q}, i)→R.

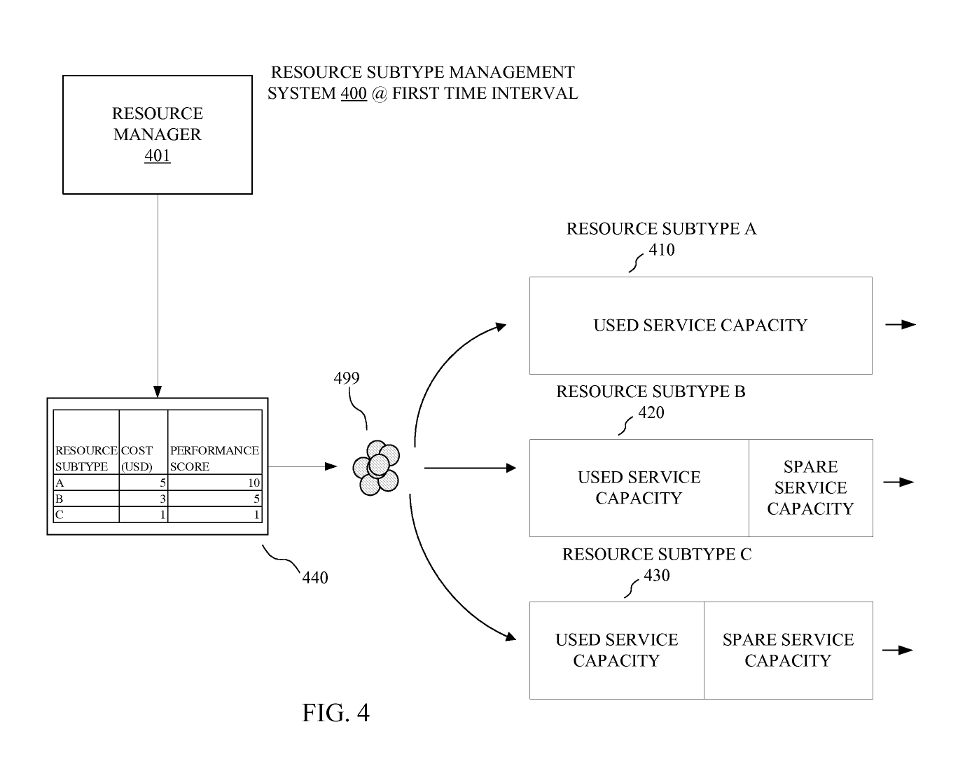

Turning now to FIG. 4, shown is a block diagram, depicted at a first time interval, of an example resource subtype management system 400 configured to manage consumer usage of a set of resource subtypes for accessing a resource. When using the resource subtype management system 400, consumers 499 desiring access to a resource may have an option of selecting from among three resource subtypes: resource subtype A 410, resource subtype B 420, and resource subtype C 430. As shown, each resource subtype may have its own service capacity. Each resource subtype's service capacity may be divided into used service capacity (e.g., the portion of the service capacity that is currently being used by consumers) and spare service capacity (e.g., the portion of the service capacity that is not being used by consumers). As shown, at the first time interval, each of the three resource subtypes have roughly equal service capacities, with different portions of their respective service capacities being used. In particular, resource subtype C 430 has a low used service capacity, resource subtype B 420 has a higher used service capacity, and resource subtype A 110 has all of its service capacity being used.

In some embodiments, a resource subtype service capacity may be considered a fixed quantity (or a fixed rate of service). For example, in the context of seats in an auditorium the service capacity may be the seating capacity of the auditorium; in this context, the service capacity (the number of seats) is fixed (unless, of course, seats are added or taken away). In some other embodiments, however, a resource subtype service capacity may vary depending on other factors, such as the minimum level of performance for that resource subtype. For example, in the context of a shared computer server, the service capacity (e.g., the number of jobs that the server can perform at a time) may be dependent upon the minimum performance guarantees that the consumers have been promised for that server. More specifically, higher minimum performance guarantees may be associated with lower service capacities, and vice versa. Furthermore, it is contemplated that, even in embodiments where total service capacity is fixed, the portion of that service capacity dedicated to any specific service category may be adjusted. For example, if there are premium seats and regular seats in auditorium, the service capacity of the premium seating category could be increased (by taking seats from the regular seating category) and yet the total service capacity of the auditorium would not change.

When deciding which resource subtype to access, consumers 499 may have some ability to make informed decisions by using an electronic service menu 440 transmitted to them by a resource manager 401. As shown, the electronic service menu 440 includes for each of the resource subtypes a cost indicator (cost for using that resource subtype in US dollars) and a benefit indicator (performance score for that resource subtype).

Based on their review of the electronic service menu 440, consumers 499 may each choose which one of the three resource subtypes (410, 420, or 430) they would like to use. In some embodiments, consumer usage data (the number of consumers currently using each resource subtype, the average performance level received by consumers using each resource subtype, etc.) may be collected and transmitted to the resource manager 401 for analysis. In some embodiments, the resource manager may be able to use this data to obtain insight into the usage of each of the resource subtypes and make calculations about the optimal relative consumer usage of each of the resource subtypes.

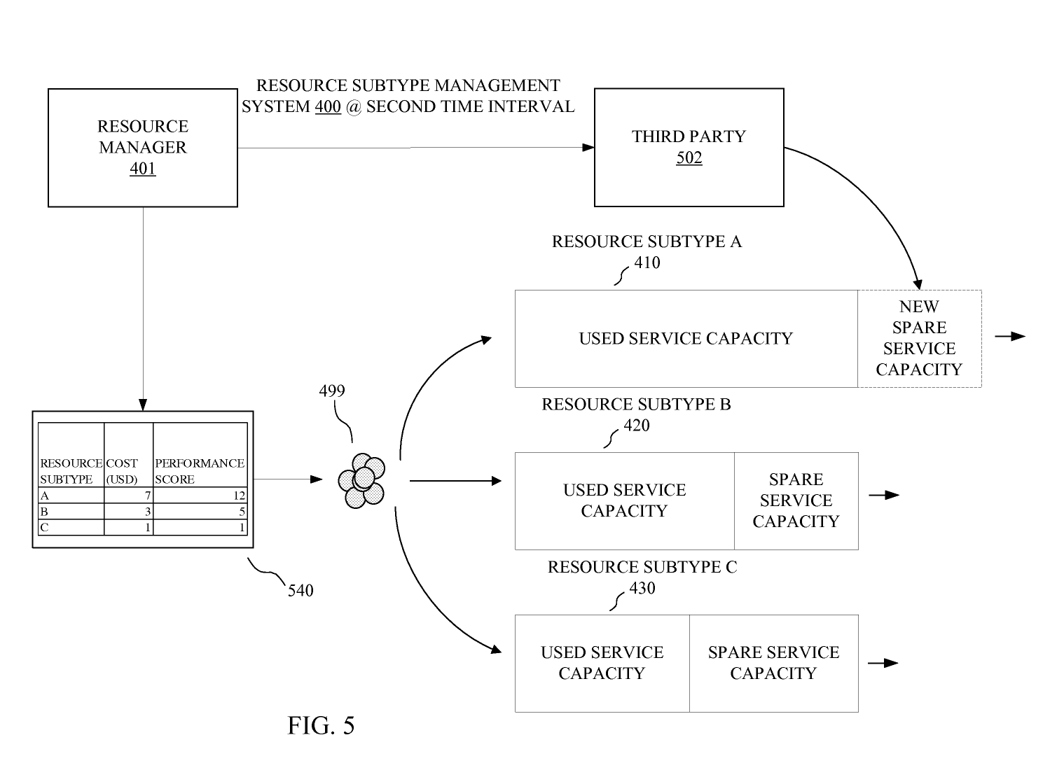

Turning now to FIG. 5, shown is the example resource subtype management system 400 of FIG. 4 depicted at a second time interval, in accordance with embodiments of the present disclosure. At this time, the resource manager 401 may determine that having all of the service capacity of resource subtype A 410 being used is a problem and, accordingly, may take corrective actions. These actions may take the form of procuring a quantity of an asset from third party 502 and using that quantity of the asset to increase the service capacity of the resource subtype A 410. In some embodiments, in order to procure this additional quantity of the asset the resource manager 401 may have to pay a price to the third party 502 (e.g., paying a third-party cloud service provider in order to get additional computing resources from them so that consumers may be served). This price may be passed on to the consumers 499 in the form of higher costs for using one or more service categories. Also, at the second time interval, the resource manager 401 may transmit to the consumers 499 a revised electronic service menu 540. In the depicted example, revised electronic service menu 540 includes, for resource subtype A 410, a revised cost indicator (in the form of a cost increased from $5 to $7) and a revised benefit indicator (in the form of a performance score increased from 10 to 12). Both of these increases may be associated with the additional service capacity added to resource subtype A 410.

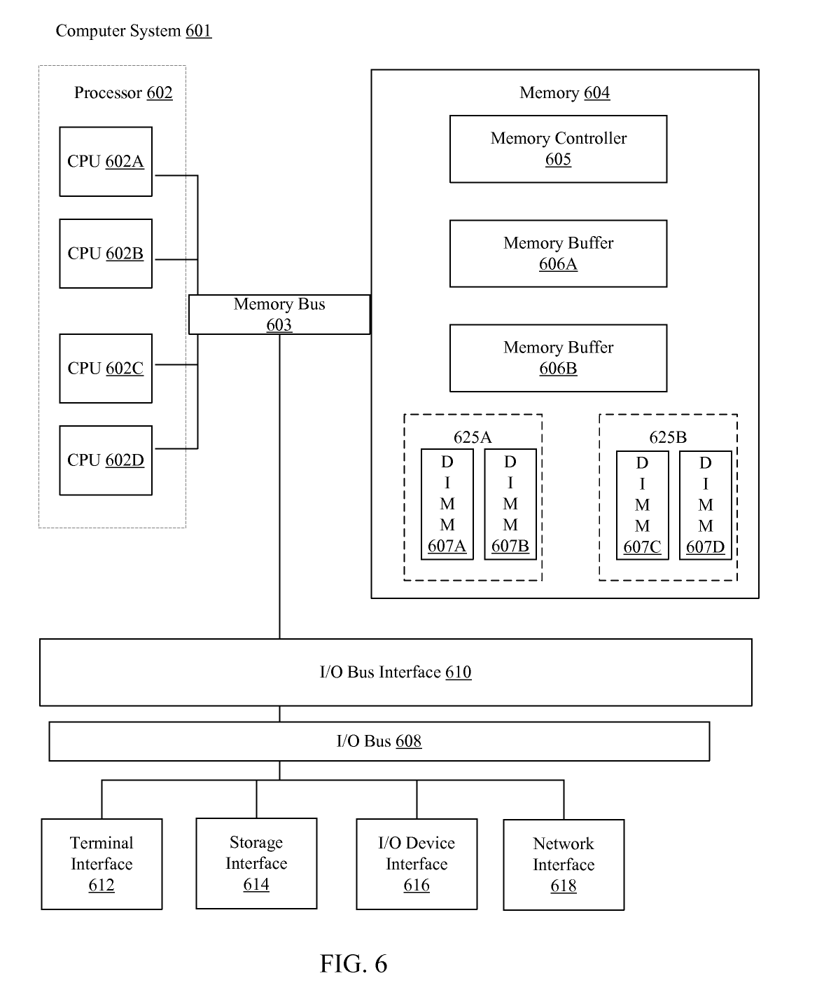

Turning now to FIG. 6, shown is a high-level block diagram of an example computer system (i.e., computer) 601 that may be used in implementing one or more of the methods, and any related functions, described herein (e.g., using one or more processor circuits or computer processors of the computer), in accordance with embodiments of the present disclosure. In some embodiments, computer system 601 may be configured to as a resource manager (e.g., resource manager 201 of FIG. 2). Further, in some embodiments, the major components of the computer system 601 may comprise one or more CPUs 602, a memory subsystem 604, a terminal interface 612, a storage interface 614, an I/O (Input/Output) device interface 616, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may comprise one or more levels of on-board cache.

In some embodiments, the memory subsystem 604 may comprise a random-access semiconductor memory, storage device, or storage medium (either volatile or non-volatile) for storing data and programs. In some embodiments, the memory subsystem 604 may represent the entire virtual memory of the computer system 601, and may also include the virtual memory of other computer systems coupled to the computer system 601 or connected via a network. The memory subsystem 604 may be conceptually a single monolithic entity, but, in some embodiments, the memory subsystem 604 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

In some embodiments, the main memory or memory subsystem 604 may contain elements for control and flow of memory used by the CPU 602. This may include all or a portion of the following: a memory controller 605, one or more memory buffers 606A and 606B and one or more memory devices 625A and 625B. In some embodiments, the memory devices 625A and 625B may be dual in-line memory modules (DIMMs), which are a series of dynamic random-access memory (DRAM) chips 607A-607D (collectively referred to as 607) mounted on a printed circuit board and designed for use in personal computers, workstations, and servers. The use of DRAMs 607 in the illustration is exemplary only and the memory array used may vary in type as previously mentioned.

Although the memory bus 603 is shown in FIG. 6 as a single bus structure providing a direct communication path among the CPUs 602, the memory subsystem 604, and the I/O bus interface 610, the memory bus 603 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

As discussed in more detail below, it is contemplated that some or all of the steps of some of the embodiments of methods described herein may be performed in alternative orders or may not be performed at all; furthermore, multiple steps may occur at the same time or as an internal part of a larger process.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of modulating consumer usage of service categories for accessing a resource, each service category having a service capacity for accessing the resource, the method comprising:
transmitting, from a computer system, an electronic service menu, the electronic service menu including a cost indicator and a benefit indicator for each of the service categories;
obtaining, by the computer system, consumer usage data about each of the service categories;
analyzing, using the computer system, the consumer usage data;
adjusting, using the computer system, based on the analysis, the service capacity of at least one of the service categories; and
transmitting, from the computer system, based on the analysis, a revised electronic service menu, the revised electronic service menu including at least one revised cost indicator and at least one revised benefit indicator.

2. The method of claim 1, wherein, prior to the adjusting, a first consumer uses a first service category, and wherein, prior to the adjusting, a cost indicator for the first service category includes a range of costs, the method further comprising:
selecting, based on the analysis, a first cost that is within the range of costs; and
charging the first consumer the first cost.

3. The method of claim 1, wherein the at least one revised benefit indicator includes a revised minimum benefit guarantee, the method further comprising:
setting, based on the adjusted service capacity, the revised minimum benefit guarantee.

4. The method of claim 1, wherein the adjusting the service capacity of the at least one of the service categories includes:
procuring a quantity of an asset from a third party; and
using the quantity of the asset to increase the service capacity of the at least one service category.

5. The method of claim 4, wherein, in response to the increased service capacity of the at least one service category, a first cost indicator for the at least one service category indicates a lower cost than a first revised cost indicator for the at least one service category.

6. The method of claim 1, further comprising:
adjusting, in response to the analysis, a cardinality of the service categories.

7. The method of claim 1, wherein, at a first time interval, a first service category is associated with a benefit indicator that includes a minimum benefit guarantee, and wherein, at a second time interval, the first service category is associated with a revised benefit indicator that includes a revised minimum benefit guarantee, the method further comprising:
setting, in response to the analysis, the revised minimum benefit guarantee at a lower level of benefit than the minimum benefit guarantee in order to increase consumer usage of the first service category during the second time interval.

8. The method of claim 1, wherein each service category is a separate queue for accessing the resource.

9. The method of claim 8, wherein each benefit indicator is a wait time for each respective separate queue.

10. The method of claim 1, wherein the resource includes resource subtypes, and wherein each service category is a separate resource subtype.

11. The method of claim 10, wherein each service capacity is a maximum number of consumers that can access each separate resource subtype at a given time.

12. The method of claim 1, wherein the adjusting, based to the analysis, the service capacity of at least one of the service categories includes:
adjusting, based on the analysis, the service capacities of all of the service categories.

13. The method of claim 8 further comprising:
charging a cost to a consumer upon the consumer's arrival at a head of a first separate queue, wherein the cost is a function of a length of the first separate queue at a time that the consumer joined the first separate queue.

14. The method of claim 8 further comprising:
charging a cost to a consumer upon the consumer's arrival at a head of a first separate queue;
revising a cost indicator for the first separate queue as a function of at least the charged cost, wherein the revised cost indicator for the first separate queue is part of the revised electronic service menu.

15. The method of claim 1, wherein the adjusting the service capacity of the at least one of the service categories causes a total service capacity for accessing the resource to be adjusted.

16. The method claim 1, wherein the obtaining, by the computer system, consumer usage data about each of the service categories includes:
tracking, using one or more electronic input devices, consumer usage of each of the service categories.

17. The method of claim 1, wherein the one or more electronic input devices include one or more automated sensors configured to monitor consumer activity.

18. A computer program product for modulating consumer usage of service categories for accessing a resource, each service category having a service capacity for accessing the resource, the computer program product comprising a computer readable storage medium having program instructions embodied therewith, the program instructions executable by a computer to cause the computer to:
transmit an electronic service menu, the electronic service menu including a cost indicator and a benefit indicator for each of the service categories;
obtain consumer usage data about each of the service categories;
analyze the consumer usage data;
adjust, based on the analysis, the service capacity of at least one of the service categories; and
transmit, based on the analysis, a revised electronic service menu, the revised electronic service menu including at least one revised cost indicator and at least one revised benefit indicator.

19. The computer program product of claim 18, wherein each service category is a separate queue for accessing the resource.

20. A system for modulating consumer usage of service categories for accessing a resource, each service category having a service capacity for accessing the resource, the system comprising one or more computer processors configured to perform a method comprising:
transmitting an electronic service menu, the electronic service menu including a cost indicator and a benefit indicator for each of the service categories;
obtaining consumer usage data about each of the service categories;
analyzing the consumer usage data;
adjusting, based on the analysis, the service capacity of at least one of the service categories; and
transmitting, based on the analysis, a revised electronic service menu, the revised electronic service menu including at least one revised cost indicator and at least one revised benefit indicator.
